(19) United States
(12) Patent Application Publication
(10) Pub. No.: US 2004/0170009 A1
(43) Pub. Date: Sep. 2, 2004

(54) [A BACK LIGHT MODULE]

(76) Inventor: Yi-Chun Ho, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/250,239

(22) Filed: Jun. 17, 2003

(30) Foreign Application Priority Data
Feb. 27, 2003 (TW) 92104141

(51) Int. Cl. F21V 8/00; F21V 29/00

(52) U.S. Cl. 362/31; 362/373

(57) ABSTRACT

A back light module comprising a light-guiding plate, a lamp, a lower frame and an upper frame is provided. The light-guiding plate has a light-emitting surface. The lamp is positioned on one side of the light-guiding plate. Light from the lamp travels towards the light-guiding plate and emerges from the light-emitting surface of the light-guiding plate. The lower frame supports the light-guiding plate and the lamp and has a plurality of heat-dissipating slots formed on the sidewall close to the lamp. The upper frame covers the lower frame and has a window for exposing the light-emitting surface of the light-guiding plate. Through the heat-dissipating slots on the sidewalls of the lower frame, excess heat produced by the lamp due to a long continuous operation is carried away.

### CROSS REFERENCE TO RELATED APPLICATIONS

This application claims the priority benefit of Taiwan application serial no. 92104141, filed Feb. 27, 2003.

### BACKGROUND OF INVENTION

1. Field of Invention

The present invention relates to a back light module. More particularly, the present invention relates to a specially designed back light module capable of removing excess heat produced by a lamp inside the module so that the back light module can operate continuously for a long period of time.

2. Description of Related Art

Thanks to the many breakthroughs in semiconductor technologies and the introduction of advanced display devices, multi-media has developed at an exceedingly fast pace. In the past, the cathode ray tube (CRT) was almost the only commercially available display device due to its superb quality and low price. However, with the advent of personal computers, other factors relating to a display device such as spatial occupation, power consumption and environmental safety have become important considering factors. Because a CRT is basically a bulky and power guzzling device, it has been gradually replaced by radiation free, high image quality, slim and power efficient displays such as liquid crystal displays (LCD).

The liquid crystal display comprises a liquid crystal panel and a back light module. Since the liquid crystals inside the panel are incapable of emitting any light, the liquid crystal panel must be illuminated from below by a planar light source such as the one produced by the back light module. Hence, the back light module is an important component in any liquid crystal display.

FIG. 1 is a diagram showing the structural layout of a conventional back light module. As shown in FIG. 1, the back light module 100 comprises a light-guiding plate (LGP) 110, a lamp 120, a reflector 130, an optical film 140, a lower frame 150 and an upper frame 160. The light-guiding plate 110 furthermore has a light incidenting surface 112, a light-diffusing surface 114 and a light-emitting surface 116. The lamp 120 is set up next to the light-incidenting surface 112 of the light-guiding plate 110. Light from the lamp 120 enters the light incidenting surface 112 of the light-guiding panel 110 to be diffused and reflected by the light-diffusing surface 114. Finally, the diffused and reflected light leaves the light-guiding plate 110 through the light-emitting surface 116. In other words, the light-guiding plate 110 is capable of transforming a beam of linear light rays from the lamp 120 into a planar light source for illuminating the entire surface of a liquid crystal panel (not shown) uniformly.

The reflector 130 is positioned on one side of the lamp so that light emitted from the lamp 120 is concentrated upon the light-receiving surface 112 of the light-guiding plate 110. The optical film 140 is positioned above the light-emitting surface 116 of the light-guiding plate 110 for increasing luminance of the back light module 100.

As shown in FIG. 1, the lower frame 150 supports the light-guiding panel 110, the lamp 120 and the reflective shroud 130. The sidewall 152 of the lower frame 150 furthermore comprises a plurality of protrusions 154. The upper frame 160 has a plurality of fasteners 162 that correspond in position to the protrusions 154. Each fastener 162 has an opening 164 suitable for latching with a protrusion 154 so that the upper frame 160 and the lower frame 150 are tightly engaged together. In addition, the upper frame 160 has a window 166 for exposing the light emitted from the light-emitting surface 116 of the light-guiding plate 110 so that a liquid crystal panel (not shown) above the upper frame 160 is illuminated by a planar light source. In brief, through the engagement of the upper frame 160 and the lower frame 150, the light-guiding panel 110, the lamp 120 and the reflector 130 are bound together into an integrative back light module 100.

Note that an almost sealed interior space is formed after joining the upper frame and the lower frame together. The sealed space prevents any excess heat produced by the lamp from escaping after a long operation. Once over-heated, the lamp may burn out thereby cutting short its working life. Furthermore, any accumulation of heat in the space between the upper frame and the lower frame also affects the molecular state of the optical film so that the planar light source will be in a state of instability. As a result of such instability, flare may appear on the liquid crystal display.

### SUMMARY OF INVENTION

Accordingly, one object of the present invention is to provide a specially designed back light module capable of removing excess heat produced by a lamp inside the module due to continuous operation. Hence, light from the back light module is prevented from flaring up as a result of heating an optical film positioned over the module.

To achieve these and other advantages and in accordance with the purpose of the invention, as embodied and broadly described herein, the invention provides a back light module. The back light module comprises a light-guiding plate, a lamp, a lower frame and an upper frame. The light-guiding plate has a light-emitting surface. The lamp is positioned on one side of the light-guiding plate. The lamp produces light that travels to the light-guiding plate and emerges from the light-emitting surface. The lower frame supports the light-guiding plate and the lamp and has a plurality of heat-dissipating slots close to the lamp. The upper frame is positioned over the lower frame. The upper frame also has a window for exposing the light-emitting surface of the light-guiding plate.

This invention also provides an alternative back light module. The back light module comprises a light-guiding plate, a plurality of lamps, a lower frame and an upper frame. The light-guiding plate has a light-emitting surface. The lamps are positioned on the sides of the light-guiding plate. The lamps produce light that travels to the light-guiding plate and emerges from the light-emitting surface. The lower frame supports the light-guiding plate and the lamps and has a plurality of heat-dissipating slots close to the lamp. The upper frame is positioned over the lower frame. The upper frame also has a window for exposing the light-emitting surface of the light-guiding plate.

According to preferred embodiment of this invention, the heat-dissipating slots are positioned on the sidewall of the lower frame close to the lamp or positioned on the bottom wall of the lower frame close to the lamp. However, the heat-dissipating slots can be positioned on both the sidewall and the bottom wall of the lower frame close to the lamp. The heat-dissipating slots are aligned in a direction parallel to the axis of the lamp. Moreover, the heat-dissipating slots can have a rectangular, circular or elliptical shape.

According to the preferred embodiment of this invention, if the back light module deploys a single lamp, the lamp can be a straight lamp tube, an L-shaped lamp tube or a U-shaped lamp tube. If a straight lamp tube is used, the light-guiding plate must have a light-receiving surface and a light-diffusing surface. Furthermore, the straight lamp tube is positioned next to the light-receiving surface of the light-guiding plate. If an L-shaped lamp tube or a U-shaped lamp tube is used, the light-guiding plate must have a plurality of light-receiving surfaces and a plurality of light-diffusing surfaces. Similarly, the L-shaped lamp tube or the U-shaped lamp is positioned next to the light-receiving surfaces.

According to the preferred embodiment of this invention, if the back light module deploys a plurality of lamps, a system having two or three straight lamp tubes or a system having one straight lamp tube and one L-shaped lamp tube can be used. Similarly, the light-guiding plate must have a plurality of light-receiving surfaces and a plurality of light-diffusing surfaces and the lamp tubes must be positioned next to the light-receiving surfaces.

According to the preferred embodiment of this invention, the sidewalls of the lower frame have a plurality of protrusions while the upper frame has a plurality of corresponding fasteners. Each fastener has an opening for engaging with a protrusion so that the upper frame and the lower frame can be locked together. Furthermore, each protrusion has a slant surface for guiding the fastener so that the protrusion may click onto the opening on the fastener with ease.

According to the preferred embodiment of this invention, an optical film is also formed on the light-emitting surface of the light-guiding plate for improving the luminance of the back light module. In addition, a reflector is installed next to the lamp. The reflector encloses the lamp so that light emitted from the lamp is focused onto the light-receiving surface of the light-guiding plate. A reflective plate is also attached to the bottom of the light-guiding plate for increasing the reflectivity and diffusive strength of the light-diffusing surface of the light-guiding plate. Hence, percentage utilization of light by the back light module is increased.

With the addition of heat-dissipating slots in the lower frame close to the lamp, heat produced by the lamp due to a long continuous operation can be removed. This setup not only extends the working life of the lamp, but also prevents the back light module from flaring due to an excessively heated optical film.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram showing the structural layout of a conventional back light module.

FIG. 2 is a diagram showing the structural layout of a back light module according to one preferred embodiment of this invention.

FIG. 3 is a perspective view of a back light module according to one preferred embodiment of this invention.

FIG. 4 is a cross-sectional view along plane A in FIG. 3.

FIGS. 5A and 5B are diagrams showing two different arrangements of a signal lamp tube relative to a light-receiving surface.

FIGS. 6A to 6C are diagrams showing three different arrangements of a multiple lamp tube system relative to the light-receiving surfaces.

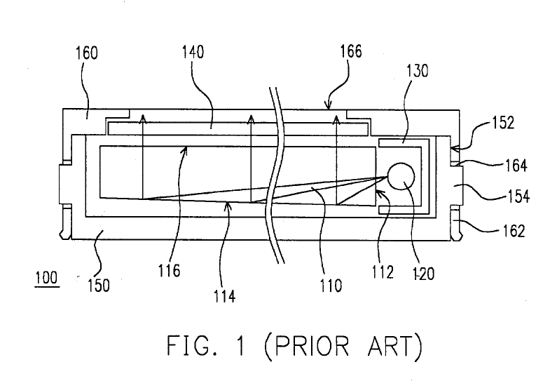

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

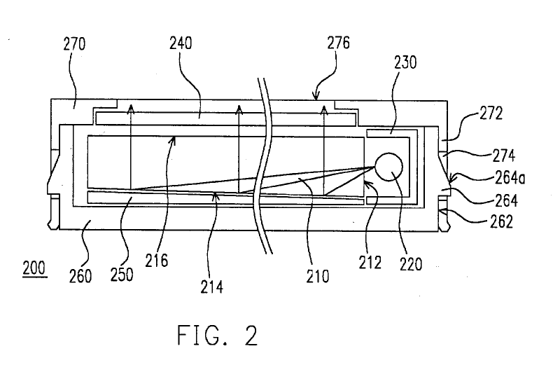

FIG. 2 is a diagram showing the structural layout of a back light module according to one preferred embodiment of this invention. As shown in FIG. 2, the back light module 200 comprises a light-guiding plate 210, a lamp 220, a reflector 230, an optical film 240, a reflective plate 250, a lower frame 260 and an upper frame 270. The light-guiding plate 210 has a light-receiving surface 212, a light-diffusing surface 214 and a light-emitting surface 216. The light-diffusing surface 214 furthermore has a plurality of V-shaped notches or a plurality of recess spots (not shown). The lamp 220 is a straight lamp positioned on one side of the light-receiving surface 212 of the light-guiding plate 210. Light from the lamp 220 enters the light-receiving surface 212 of the light-guiding plate 210 and travels to the light-diffusing surface 214. There, the light is dispersed and reflected before emerging from the light-guiding plate 210 through the light-emitting surface 216. In other words, the light-guiding plate 210 serves to convert the light from a linear light source to a planar light source so that a liquid crystal panel (not shown) over the back light module is uniformly illuminated.

The reflector 230 is positioned next to the lamp 220. The reflector 230 encloses the lamp 220 so that light emitted from the lamp 220 is focused upon the light-receiving surface 212 of the light-guiding plate 210. The optical film 240 is positioned on top of the light-emitting surface 216 of the light-guiding plate 210 for increasing the luminance level of the back light module 200. The reflective plate 250 is positioned at the bottom of the light-guiding plate 210 for increasing the reflectivity and diffusive strength of the light-diffusing surface 214 so that overall utilization of light by the back light module 200 is increased. Through the reflector 230, the optical film 240 and the reflective plate 250, the planar light from the back light module 200 is able to provide a brightness level that meets the high resolution demanded for all liquid crystal displays.

The lower frame 260 supports the light-guiding plate 210, the lamp 220 and the reflector 230. The sidewalls of the lower frame 260 also have a plurality of protrusions 264 and the upper frame 270 has a plurality of corresponding fasteners 272. Each fastener 272 has an opening 274 suitable for latching onto a protrusion 264 so that the upper frame 270 and the lower frame 260 are locked together. In addition, each protrusion 264 has a slant surface 264a for guiding the opening 274 of a fastener 272 so that the protrusion 264 can click into the opening 274 with ease. Furthermore, the upper frame 270 has a window 276 for exposing the light-emitting surface 216 of the light-guiding plate 210 so that light from the light-emitting surface 216 can illuminate the entire liquid crystal panel (not shown) above the upper frame 270.

By meshing the upper frame 270 with the lower frame 260, the light-guiding plate 210, the lamp 220 and the reflector 230 are fixed relative to each other inside an integrative back light module 200.

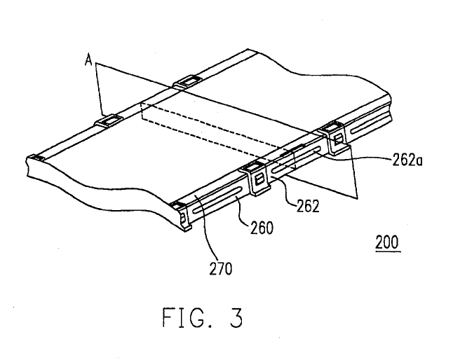

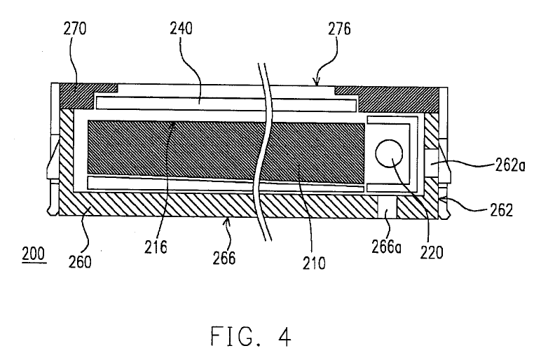

FIG. 3 is a perspective view of a back light module according to one preferred embodiment of this invention. FIG. 4 is a cross-sectional view along plane A in FIG. 3. As shown in FIGS. 3 and 4, the sidewalls 262 of the lower frame 260 close to the lamp 220 have a plurality of heat-dissipating slots 262a. Similarly, the bottom wall 266 of the lower frame 260 close to the lamp 220 has a plurality of heat-dissipating slots 266a. The heat-dissipating slots 262a and 266a are aligned in a direction parallel to the axis of the lamp 220. These heat-dissipating slots 262a, 266a can have, for example, a rectangular, a circular or an elliptical shape. In the presence of these heat-dissipating slots 262a and 266a, the space between the upper frame 270 and the lower frame 260 is ventilated. Since the heat-dissipating slots (262a, 266a) remove excess heat produced by the lamp due to a long operating period, working life of the lamp 220 can be increased. Furthermore, without overheating the optical film 240 inside the back light module 200, flaring of the planar light is prevented. Ultimately, quality of the planar light source illuminating the liquid crystal display is improved.

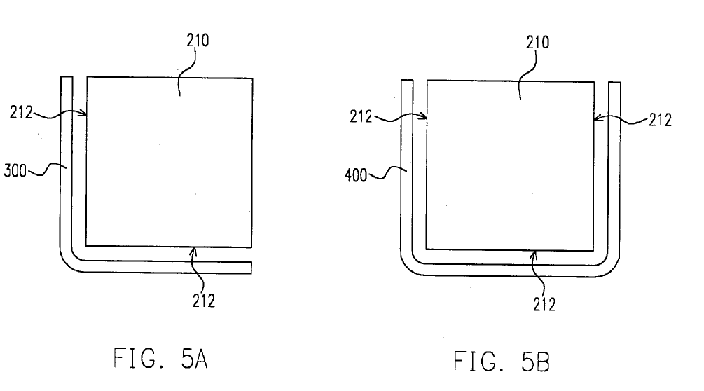

FIGS. 5A and 5B are diagrams showing two different arrangements of a signal lamp tube relative to a light-receiving surface. Only a single straight lamp is used in the back light module 200 as shown in FIGS. 2 to 4. However, other forms of lamp tubes can be used as well. For example, a single L-shaped lamp tube 300 as shown in FIG. 5A and a single U-shaped lamp tube 400 as shown in FIG. 5B can be used. If a single L-shaped lamp tube 300 is used inside the back light module 200, the light-guiding panel 210 must have two light-receiving surfaces 212 and two light-diffusing surfaces (not shown). Moreover, the two light-receiving surfaces 212 must correspond in position to the L-shaped lamp tube 300. If a single U-shaped lamp tube 400 is used inside the back light module 200, the light-guiding panel 210 must have three light-receiving surfaces 212 and three light-diffusing surfaces (not shown). Moreover, the three light-receiving surfaces 212 must correspond in position to the U-shaped lamp tube 400.

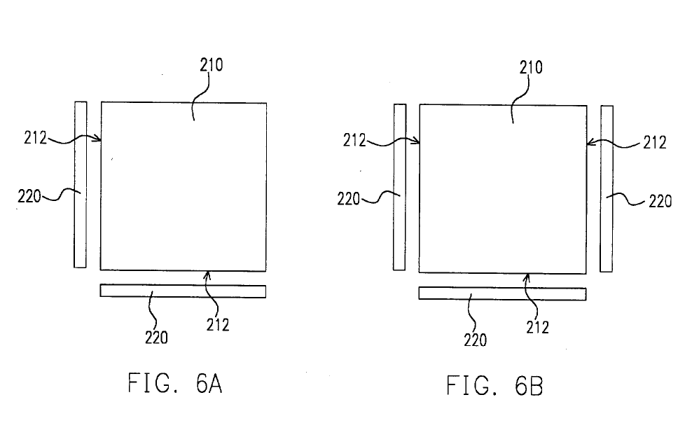

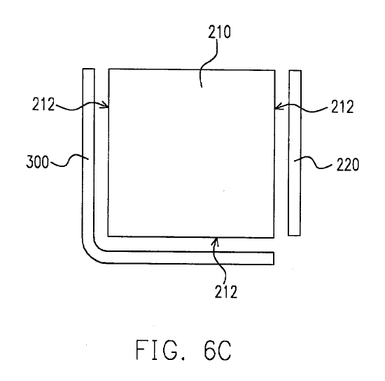

FIGS. 6A to 6C are diagrams showing three different arrangements of a multiple lamp tube system relative to the light-receiving surfaces. As shown in FIGS. 6A to 6C, aside from a single lamp tube, a multiple of lamp tubes may be deployed inside a back light module 200. For example, a combination of two straight lamp tubes 220 as shown in FIG. 6A or a combination of three straight lamp tubes 220 as shown in FIG. 6B can be used. Alternatively, a combination of a single straight lamp tube 220 and a single L-shaped lamp tube 300 as shown in FIG. 6C can be used. If a pair of straight lamp tubes 220 is used (as shown in FIG. 6A), the light-guiding panel 210 must have two light-receiving surfaces 212 and two light-diffusing surfaces (not shown) and the two straight lamp tubes 220 must correspond in position with the light-receiving surfaces 212. If three straight lamp tubes 220 (as shown in FIG. 6B) or a straight lamp tube 220 and an L-shaped lamp tube 300 is used, the light-guiding panel 210 must have three light-receiving surfaces 212 and three light-diffusing surface (not shown). Moreover, the straight lamp tube 220 and L-shaped lamp tube 300 must correspond in position to the light-receiving surfaces 212.

Note that the heat-dissipating slots are positioned on the sidewalls and the bottom wall of the lower frame close to the lamp tubes. However, this is not the only means of positioning the heat-dissipating slots. The heat-dissipating slots may be positioned only on the sidewalls of the lower frame close to the lamp tubes or positioned only on the bottom wall of the lower frame close to the lamp tubes.

In general, no matter how many single or multiple lamp tubes are installed inside the back light module of this invention, the plurality of heat-dissipating slots on the sidewalls or bottom wall of the lower frame is able to channel excess heat away. Hence, the back light module can be used continuously for a long period of time without overheating.

In conclusion, the back light module according to this invention has the following major advantages: 1. The back light module has an effective means of removing excess heat produced by the lamp due to a long operation so that overall working life of the lamp is extended. 2. By removing excess heat from the lamp inside the back light module, the optical film above the module will not overheat and hence prevents the flaring of planar light from the module for illuminating the liquid crystal display.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A back light module, comprising:
a light-guiding plate having a light-emitting surface;
a lamp positioned on one side of the light-guiding plate, wherein light from the lamp travels to the light-guiding plate and emerges from the light-emitting surface of the light-guiding plate;
a lower frame for holding the light-guiding plate and the lamp, wherein the lower frame has a plurality of heat-dissipating slots close to the lamp; and
an upper frame positioned over the lower frame, wherein the upper frame has a window for exposing the light-emitting surface of the light-guiding plate.

2. The back light module of claim 1, wherein the heat-dissipating slots are aligned in a direction parallel to the axis of the lamp.

3. The back light module of claim 1, wherein the heat-dissipating slots are formed on the sidewalls of the lower frame close to the lamp.

4. The back light module of claim 1, wherein the heat-dissipating slots are formed on the bottom wall of the lower frame close to the lamp.

5. The back light module of claim 1, wherein the heat-dissipating slots are formed on the sidewalls and the bottom wall of the lower frame close to the lamp.

6. The back light module of claim 1, wherein the heat-dissipation slots have a rectangular shape, a circular shape or an elliptical shape.

7. The back light module of claim 1, wherein the light-guiding panel furthermore comprises a light-receiving surface and a light-diffusing surface and the lamp is a straight lamp tube positioned to correspond with the light-receiving surface of the light-guiding module.

8. The back light module of claim 1, wherein the light-guiding panel furthermore comprises a plurality of light-receiving surfaces and a plurality of light-diffusing surfaces, and the lamp is an L-shaped lamp tube positioned to correspond with the light-receiving surfaces of the light-guiding panel.

9. The back light module of claim 1, wherein the light-guiding panel furthermore comprises a plurality of light-receiving surfaces and a plurality of light-diffusing surfaces, and the lamp is a U-shaped lamp tube positioned to correspond with the light-receiving surfaces of the light-guiding plate.

10. The back light module of claim 1, wherein the sidewalls of the lower frame have a plurality of protrusions and the upper frame has a plurality of corresponding fasteners, and each fastener has an opening for engaging with a protrusion so that the upper frame and the lower frame can be locked together.

11. The back light module of claim 10, wherein each protrusion has a slant surface for guiding the fastener so that the protrusion can latch onto the opening in the fastener with ease.

12. The back light module of claim 1, wherein the module furthermore comprises at least an optical film positioned on the light-emitting surface of the light-guiding plate.

13. The back light module of claim 1, wherein the module furthermore comprises a reflector positioned in such a way that the lamp is entirely surrounded.

14. The back light module of claim 1, wherein the module furthermore comprises a reflector positioned at the bottom of the light-guiding plate.

15. A back light module, comprising:
a light-guiding plate having a light-emitting surface;
a plurality of lamps positioned around the light-guiding plate, wherein light from the lamps all travels to the light-guiding plate and emerges from the light-emitting surface of the light-guiding plate;
a lower frame for supporting the light-guiding plate and the lamps, wherein the lower frame also has a plurality of heat-dissipating slots close to the lamps; and
an upper frame positioned over the lower frame, wherein the upper frame also has a window for exposing the light-emitting surface.

16. The back light module of claim 15, wherein the heat-dissipating slots are aligned in a direction parallel to the axis of the lamps.

17. The back light module of claim 15, wherein the heat-dissipating slots are positioned on the sidewalls of the lower frame close to the lamps.

18. The back light module of claim 15, wherein the heat-dissipating slots are positioned on the bottom wall of the lower frame close to the lamps.

19. The back light module of claim 15, wherein the heat-dissipating slots are positioned on the sidewalls and bottom wall of the lower frame close to the lamps.

20. The back light module of claim 15, wherein the heat-dissipating slots have a rectangular shape, a circular shape or an elliptical shape.

21. The back light module of claim 15, wherein the light-guiding plate furthermore comprises a plurality of light-receiving surfaces and a plurality of light-diffusing surfaces and the lamps comprise two or three straight lamp tubes with the straight lamp tubes positioned to correspond with the light-receiving surfaces of the light-guiding module.

22. The back light module of claim 15, wherein the light-guiding plate furthermore comprises a plurality of light-receiving surfaces and a plurality of light-diffusing surfaces, and the lamp comprises a straight lamp tube and an L-shaped lamp tube both positioned to correspond with the light-receiving surfaces of the light-guiding plate.

23. The back light module of claim 15, wherein the sidewalls of the lower frame have a plurality of protrusions and the upper frame has a plurality of corresponding fasteners, and each fastener has an opening for engaging with a protrusion so that the upper frame and the lower frame can be locked together.

24. The back light module of claim 23, wherein each protrusion has a slant surface for guiding the fastener so that the protrusion can latch onto the opening in the fastener with ease.

25 The back light module of claim 15, wherein the module furthermore comprises at least an optical film positioned on the light-emitting surface of the light-guiding plate.

26. The back light module of claim 15, wherein the module furthermore comprises a reflector positioned in such a way that the lamp is entirely surrounded.

27. The back light module of claim 15, wherein the module furthermore comprises a reflective plate positioned at the bottom of the light-guiding panel.
